(19) United States
(12) Patent Application Publication
(10) Pub. No.: US 2002/0180205 A1
(43) Pub. Date: Dec. 5, 2002

(54) Apparatus for releasable engagement with a clipboard

(76) Inventor: Zane W. Anderson, Rochester, NY (US)

Correspondence Address: Zane W. Anderson, 6 Dortmund Circle, Rochester, NY, 14624, US

(21) Appl. No.: 10/157,548

(22) Filed: May 29, 2002

Related U.S. Application Data
(60) Provisional application No. 60/294,060, filed on May 29, 2001.

(51) Int. Cl. B42D 3/00

(52) U.S. Cl. 281/45

(57) ABSTRACT

An apparatus for releasable engagement with a clipboard, the clipboard having longitudinally extending peripheral edges, laterally extending peripheral edges, and a clip disposed proximate to one of the laterally extending peripheral edges, the apparatus comprising: a base having first and second opposing edges extending in a longitudinal direction and third and fourth opposing edges extending in a lateral direction, the edges defining a plane; and first and second sides coupled to the respective first and second edges of the base and extending transversely therefrom with respect to the plane, each of the first and second opposing sides including a longitudinal channel extending in the longitudinal direction and being operable to slidably receive a respective one of the longitudinally extending peripheral edges of the clipboard.

### CROSS-REFERENCE TO RELATED APPLICATIONS

This application is based upon and claims the benefit of priority from the prior U.S. Provisional Patent Application No. 60/294,060, filed May 29, 2001, entitled “APPARATUS FOR RELEASABLE ENGAGEMENT WITH A CLIPBOARD,” the entire contents of which are incorporated herein by reference.

### BACKGROUND OF THE INVENTION

The present invention relates to an apparatus for releasably engaging a clipboard and, more particularly, an apparatus for defining a cavity that may be covered by a clipboard when the clipboard is engaged with the apparatus.

Various products have been proposed to couple a clipboard to a base, where the base forms a cavity that is at least partially covered by the clipboard. These proposals, however, each require a non-standard clipboard to some extent.

By way of example, U.S. Pat. No. 4,896,927 discloses a combination clipboard and case, where the clipboard is pivotally coupled to the case such that the clipboard may be pivoted upward and away from the case to expose an interior volume of the case. Unfortunately, the clipboard requires various non-standard items, such as a pivoting means for pivotally coupling the clipboard to the case. Another combination clipboard and case recently marketed by Saunders of Winthrop, Me., called the SLIDE-RITE™, employs a non-standard clipboard that is laterally slidable into a case. Among the non-standard aspects of the clipboard are the unusually high flexibility of the clipboard (that permits it to be received into the case) and the slightly longer longitudinal dimension of the clipboard in order to provide clearance near the clip to engage a slot of the case.

Accordingly, it would be desirable to provide an apparatus that is engagable with a standard clipboard such as a standard sized masonite clipboard from A&W.

### SUMMARY OF THE INVENTION

In accordance with at least one aspect of the present invention, an apparatus is provided for releasable engagement with a clipboard. The clipboard includes longitudinally extending peripheral edges, laterally extending peripheral edges, and a clip disposed proximate to one of the laterally extending peripheral edges. The apparatus preferably includes: a base having first and second opposing edges extending in a longitudinal direction and third and fourth opposing edges extending in a lateral direction, the edges defining a plane; and first and second sides coupled to the respective first and second edges of the base and extending transversely therefrom with respect to the plane, each of the first and second opposing sides including a longitudinal channel extending in the longitudinal direction and being operable to slidably receive a respective one of the longitudinally extending peripheral edges of the clipboard.

Preferably, the clipboard is a standard sized clipboard that does not require any specialized components to engage the apparatus. For example, the clipboard preferably measures 6″×9″, 9″×12½″, and 9″×15½″.

Preferably, the apparatus includes third and fourth sides coupled to the respective third and fourth edges of the base and extending transversely therefrom with respect to the plane, wherein the base and the sides form a cavity that is closed when the longitudinally extending peripheral edges of the clipboard are fully received in the longitudinal channels of the first and second sides. It is most preferred that one of the third and fourth sides includes a movable locking member operable to retain the clipboard in engagement with the longitudinal channels when in a first position and to release the clipboard for slidable removal from the longitudinal channels when in a second position. The moveable locking member preferably includes an engagement member operable to contact one of the laterally extending peripheral edges of the clipboard when in the first position to prevent substantial sliding movement of the clipboard in the longitudinal channels. It is most preferred that the engagement member is operable to retract in a transverse direction with respect to the plane to achieve the second position.

### BRIEF DESCRIPTION OF THE DRAWINGS

For the purpose of illustrating the invention, there are shown in the drawings forms that are presently preferred, it being understood, however, that the invention is not limited to the precise arrangements and instrumentalities shown.

FIG. 1 is a perspective view of a housing and clipboard in accordance with the present invention in a disengaged configuration;

FIG. 2 is a perspective view of the housing and clipboard of FIG. 1 in an engaged configuration;

FIG. 3A is a sectional view of the housing taken along line 3A-3A of FIG. 1;

FIG. 3B is a perspective view of a portion of the housing of FIG. 1 labeled 3B;

FIG. 4 is a sectional view taken through line 4-4 of FIG. 1;

FIG. 5 is a perspective view of the housing and clipboard of FIG. 1 in an alternative engaged configuration as compared with FIG. 2;

FIG. 6 is a sectional view taken through line 6-6 of FIG. 1; and

FIG. 7 is a perspective view of an alternative housing and clipboard in an engaged and disengaged configuration in accordance with one or more further aspects of the present invention.

### DETAILED DESCRIPTION

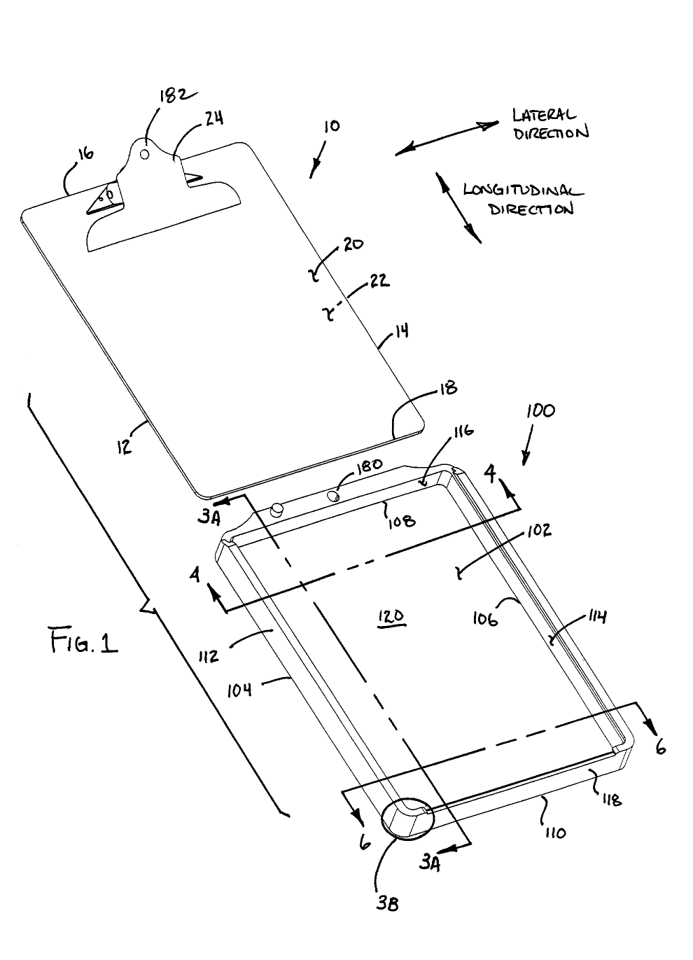

Referring now to the drawings, wherein like numerals indicate like elements, there is shown in FIG. 1 a perspective view of a housing 100 and clipboard 10 in a disengaged configuration in accordance with one or more aspects of the present invention. The clipboard 10 preferably includes longitudinally extending peripheral edges 12, 14 and laterally extending peripheral edges 16, 18. The clipboard 10 includes first and second opposing surfaces 20, 22 circumscribed by the peripheral edges 12, 14, 16, and 18. A clip 24 is preferably disposed on the first surface 20 proximate to one of the laterally extending peripheral edges, such as edge 16. Substantial advantages of the invention are achieved when the clipboard 10 is a standard configuration clipboard, such as a masonite chipboard manufactured by A&W, it being understood that, although preferred, a standard configuration clipboard is not necessary to practicing the invention. Standard configuration clipboards are manufactured in three popular sizes, namely, notepad, letter, and legal sizes. A standard notepad sized clipboard measures approximately 6″×9″. A standard letter sized clipboard measures about 9″×12½″. A standard legal sized clipboard measures about 9″×15½″. As will be apparent from the disclosure herein, a given housing 100 is advantageously designed to engage one of these standard sized clipboards without the need for non-standard components incorporated with the clipboard 10.

The housing 100 preferably includes a base 102 having first and second opposing edges 104, 106 extending in a longitudinal direction. The base 102 also preferably includes third and fourth opposing edges 108, 110 extending in a lateral direction. The longitudinal and lateral directions are illustrated by way of arrows in FIG. 1. The base 102 and, more particularly, the opposing edges 104, 106, 108, and 110, define a plane.

The housing 100 preferably includes first and second sides 112, 114 coupled to the respective first and second edges 104, 106 of the base 102. The first and second sides 112, 114 each preferably extend transversely from the base 102 (e.g., extending substantially perpendicular to the plane). The housing 100 also preferably includes third and fourth sides 116, 118 coupled to the respective third and fourth edges 108, 110 of the base 102. The third and fourth sides 116, 118 also preferably extend transversely from the base 102 (e.g., extending substantially perpendicular to the plane).

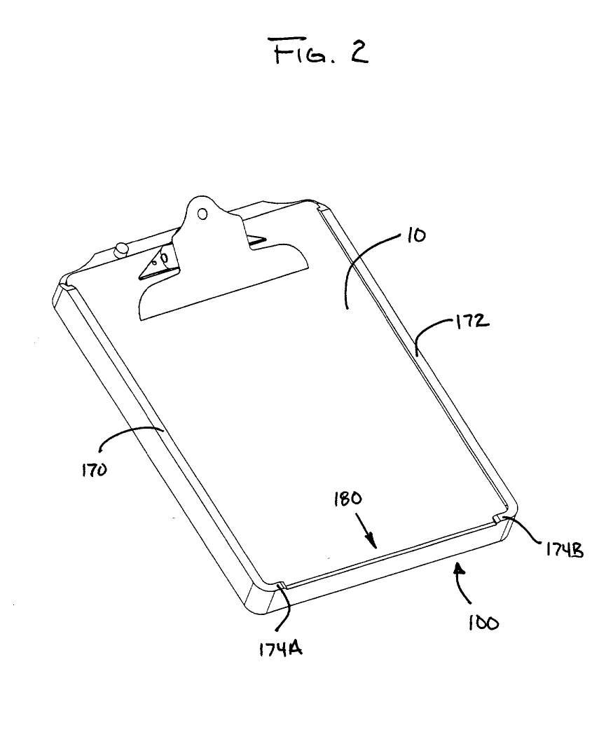

The base 102 and the sides 112, 114, 116, and 118 preferably form a cavity 120. The housing 100 is preferably operable to engage the clipboard 10 such that the cavity 120 is closed when the clipboard 10 is fully engaged with the housing 100 as shown in FIG. 2.

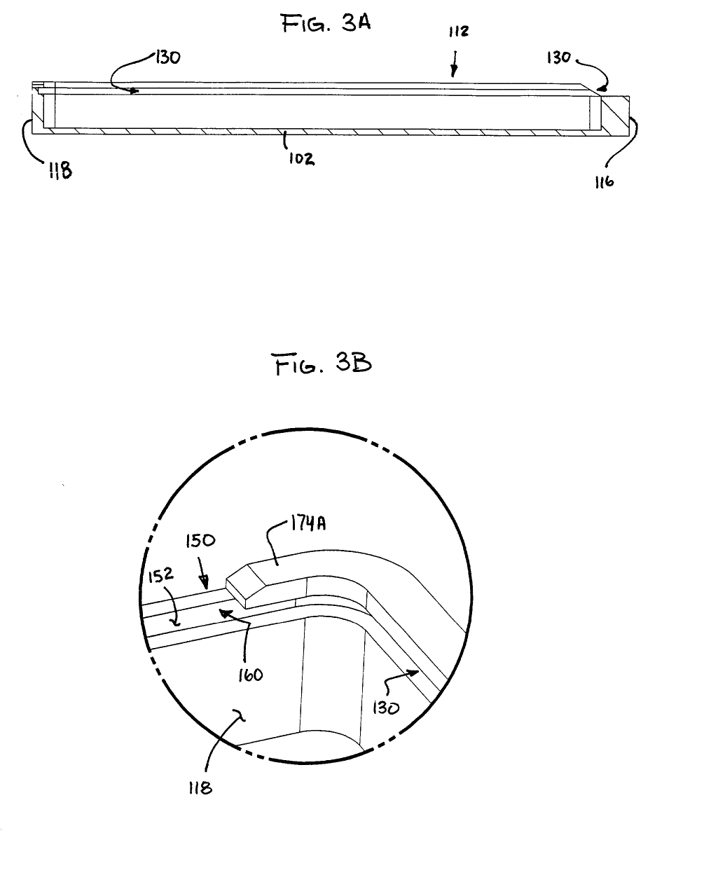

Reference is now made to FIG. 3A, which is a sectional view taken through line 3A-3A of FIG. 1. The first side 112 preferably includes a longitudinal channel 130 extending in the longitudinal direction. Preferably, the first and second sides 112, 114 mirror each other and the second side 114 includes a substantially similar longitudinal channel 130. The longitudinal channels 130 of the first and second sides 112, 114 are preferably operable to slidably receive the longitudinally extending peripheral edges 12, 14 of the clipboard 10.

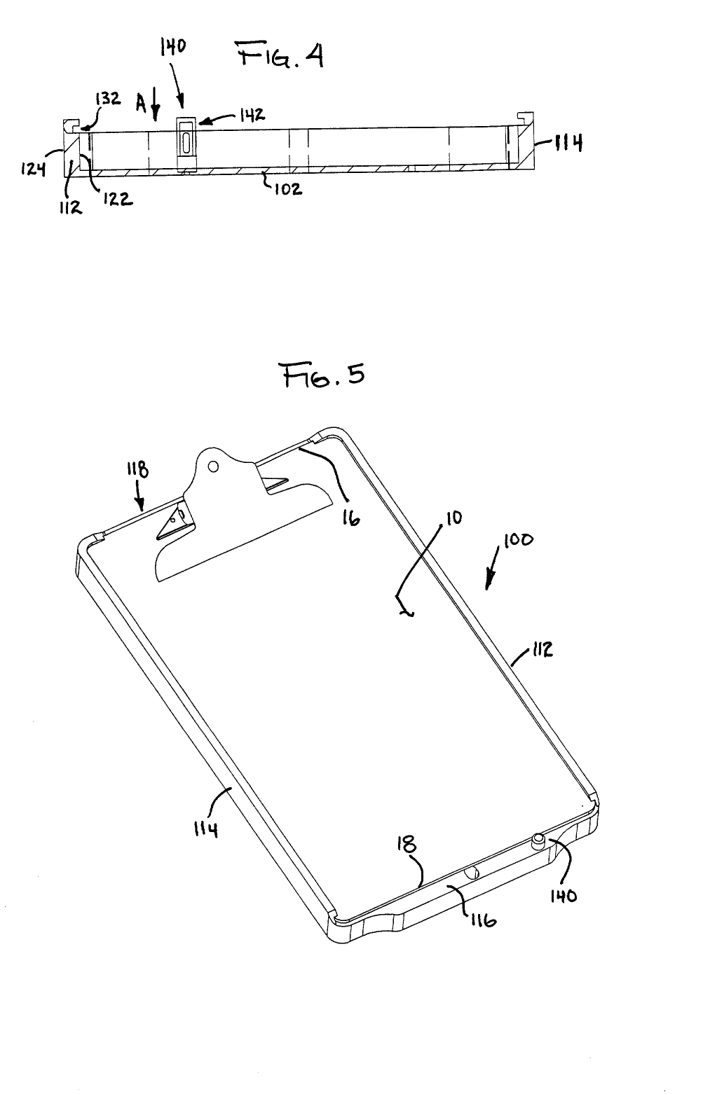

Reference is now made to FIG. 4, which is a sectional view of the first side 112 taken through line 4-4 of FIG. 1. It is understood that the second side 114 is preferably a mirror of the first side 112. The first side 112 (and by extension the second side 114) includes an inner surface 122 partially circumscribing the cavity 120 and an opposing outer surface 124. It is preferred that the longitudinal channel 130 is formed in communication with the inner surface 122 of the first side 112. Among the many techniques for forming a longitudinal channel, it is preferred that the longitudinal channel 130 of the present invention includes a notch 132 that is recessed from the inner surface 122. Other techniques are contemplated for forming the longitudinal channel 130, such as the use of inwardly extending ridges (not shown) or any of the other known techniques.

The third side 116 preferably includes a moveable locking member 140 operable to retain the clipboard 10 in engagement with the longitudinal channels 130. More particularly, the moveable locking member 140 is preferably operable to achieve at least a first position (as shown) that retains the clipboard 10 in engagement with the housing 100. In this regard, the moveable locking member 140 preferably includes an engagement member (or surface) 142 operable to contact one of the laterally extending peripheral edges 16, 18 of the clipboard 10 in order to prevent substantial sliding movement of the clipboard 10 in the longitudinal channels 130.

The clipboard 10 may be slid into the housing 100 such that the engagement member 142 contacts the first laterally extending peripheral edge 16 of the clipboard 10 (e.g., as shown in FIG. 2). Alternatively, the clipboard 10 may be slid into the housing 100 such that the engagement member 142 contacts the second laterally extending peripheral edge 18 of the clipboard 10 (e.g., as shown in FIG. 5). This may be achieved by inserting the first laterally extending peripheral edge 16 of the clipboard 10 into the housing 100 and fully sliding the clipboard 10 along the longitudinal channels 130 until the engagement member 142 engages the second laterally extending peripheral edge 18 of the clipboard 10.

Preferably, the moveable locking member 140 is biased toward the first position but may be moved into a second position that permits the release of the clipboard 10 from the housing 100. It is also contemplated that the second position of the moveable locking member 140 permits the clipboard 10 to be inserted into the longitudinal channels 130. More particularly, the engagement member 142 of the moveable locking member 140 is preferably operable to retract in a transverse direction with respect to the plane of the base 102 to achieve the second position. By way of example, the engagement member 142 may be spring-biased such that it may be retracted into the second side 116 of the housing 100, as shown by arrow A. Alternatively, the engagement member 142 may be pivotally biased to achieve partial retraction into the second side 116 (not shown). In either case, it is preferred that a force necessary to cause retraction of the engagement member 142 at least partially into the second side 116 is sufficiently low to substantially avoid flexion of the clipboard 10 when the clipboard 10 is slid into (or out of) the longitudinal channels 130 (e.g., when the clipboard 10 passes over the locking member 140).

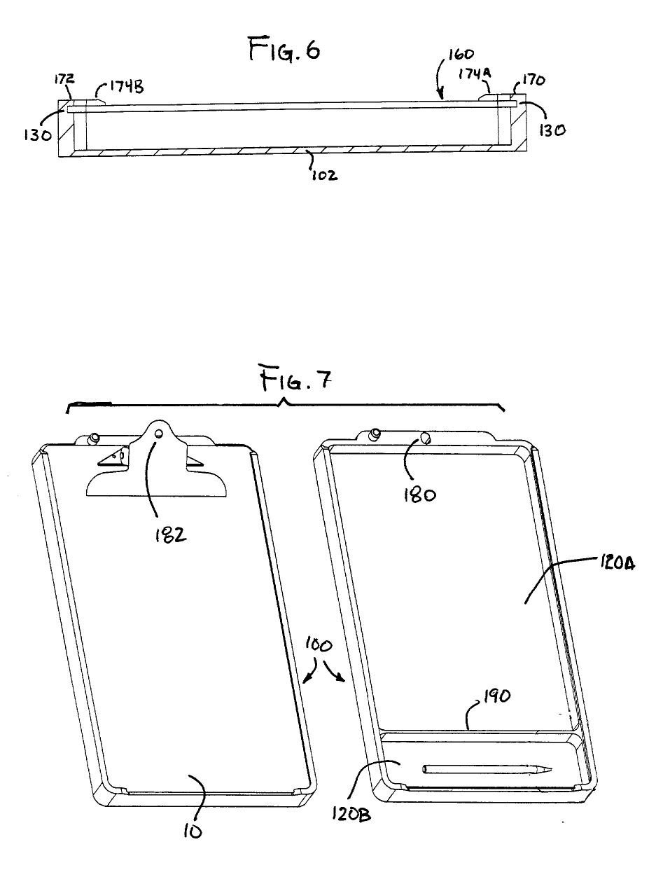

With reference to FIG. 3B, the fourth side 118 preferably includes a laterally extending channel 160 operable to receive one of the laterally extending peripheral edges 16, 18 of the clipboard 10. The fourth side 118 preferably includes a stop 150 having at least one surface 152 operable to engage one of the laterally extending edges 16, 18 of the clipboard 10 to retain the clipboard 10 in engagement with the longitudinal channels 130. As best seen in FIG. 6, it is most preferred that the at least one surface 152 is operable to extend along an entire length of the fourth side 118 and, by extension, an entire length of the laterally extending edge 18 of the clipboard 10. Preferably, the longitudinally extending channels 130 and the laterally extending channel 160 are substantially coplanar and form a substantially contiguous channel.

As best seen in FIGS. 2 and 6, the channels 130, 160 preferably form respective rims 170, 172, 174 that overly a portion of the first surface 20 of the clipboard 10 at the respective peripheral edges 12, 14, 18 of the clipboard 10. Preferably, the rim 174 formed by the laterally extending channel 160 is discontinuous such that a portion 180 of the first surface 20 of the clipboard 10 at the forth laterally extending peripheral edge 18 is not obstructed by the rim 174. More particularly, the rim 174 formed by the laterally extending channel 160 preferably includes first and second rim portions 174A, 174B disposed at respective ends of the forth side 118.

As best send in FIGS. 1 and 7, the housing 100 preferably includes an aperture 180 extending transversely with respect to the plane through the third side 116. It is most preferred that the aperture 180 is located such that it is in substantial alignment with an aperture 182 of the clipboard 10 used to hang the clipboard.

With reference to FIG. 7, the housing 100 may alternatively include at least a fifth side 190 extending transversely from the base 102 such that the cavity 120 includes two or more cavities. For example, the fifth side 190 may laterally traverse the base 102 to create first cavity 120A and second cavity 120B. When the housing 100 in accordance with this embodiment of the invention is used to engage a legal sized clipboard 10 (e.g., measuring 9″×15½″), the first cavity 120A may be sized to carry letter-sized paper (e.g., measuring 8½″×11″) while the second cavity 120B may be sized to carry other items, such as pencils, pens, tape, etc. Advantageously, however, the clipboard 10 may cover both cavities 120A, 120B when fully engaged with the housing 100.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. An apparatus for releasable engagement with a clipboard, the clipboard having longitudinally extending peripheral edges, laterally extending peripheral edges, and a clip disposed proximate to one of the laterally extending peripheral edges, the apparatus comprising:
a base having first and second opposing edges extending in a longitudinal direction and third and fourth opposing edges extending in a lateral direction, the edges defining a plane; and
first and second sides coupled to the respective first and second edges of the base and extending transversely therefrom with respect to the plane, each of the first and second opposing sides including a longitudinal channel extending in the longitudinal direction and being operable to slidably receive a respective one of the longitudinally extending peripheral edges of the clipboard.

2. The apparatus of claim 1, further comprising third and fourth sides coupled to the respective third and fourth edges of the base and extending transversely therefrom with respect to the plane, wherein the base and the sides form a cavity that is closed when the longitudinally extending peripheral edges of the clipboard are fully received in the longitudinal channels of the first and second sides.

3. The apparatus of claim 2, further comprising at least a fifth side extending transversely from the base such that the cavity includes two or more cavities.

4. The apparatus of claim 2, wherein the first and second sides include respective inner surfaces partially circumscribing the cavity and respective opposing outer surfaces, and each longitudinal channel is formed in communication with a respective one of the inner surfaces.

5. The apparatus of claim 4, wherein each longitudinal channel includes a notch that is recessed from a respective one of the inner surfaces.

6. The apparatus of claim 2, wherein one of the third and fourth sides includes a laterally extending channel operable to receive one of the laterally extending peripheral edges of the clipboard.

7. The apparatus of claim 6, wherein the longitudinally extending channels and the laterally extending channel are substantially coplanar and form a substantially contiguous channel.

8. The apparatus of claim 6, wherein:
the clipboard includes first and second opposing surfaces circumscribed by the peripheral edges and the clip is disposed on the first surface; and
the channels form respective rims that overly a portion of the first surface of the clipboard at the respective peripheral edges of the clipboard.

9. The apparatus of claim 8, wherein the rim formed by the laterally extending channel is discontinuous such that a portion of the first surface of the clipboard at the one laterally extending peripheral edge is not obstructed by the rim.

10. The apparatus of claim 2, wherein one of the third and fourth sides includes a movable locking member operable to retain the clipboard in engagement with the longitudinal channels when in a first position and to release the clipboard for slidable removal from the longitudinal channels when in a second position.

11. The apparatus of claim 10, wherein the movable locking member is biased toward the first position.

12. The apparatus of claim 10, wherein the movable locking member includes an engagement member operable to contact one of the laterally extending peripheral edges of the clipboard when in the first position to prevent substantial sliding movement of the clipboard in the longitudinal channels.

13. The apparatus of claim 12, wherein the engagement member is operable to retract in a transverse direction with respect to the plane to achieve the second position.

14. The apparatus of claim 13, wherein a force necessary to cause retraction of the engagement member is sufficiently low to substantially avoid flexion of the clipboard when the clipboard is slid into the longitudinal channels and passes over the locking member.

15. The apparatus of claim 10, wherein the other of the third and fourth sides includes a stop having at least one surface operable to engage one of the laterally extending edges of the clipboard to retain the clipboard in engagement with the longitudinal channels.

16. The apparatus of claim 15, wherein the at least one surface is operable to extend along the one of the laterally extending edges in its entirety.

17. The apparatus of claim 2, wherein one of the third and fourth sides includes an aperture extending transversely with respect to the plane and located such that it is in substantial alignment with an aperture of the clipboard used to hang the clipboard.
